(19) United States
(12) Patent Application Publication
(10) Pub. No.: US 2005/0035472 A1
(43) Pub. Date: Feb. 17, 2005

(54) Device for enriching air with an air treatment agent

(76) Inventor: Jorg Peter Schur, Wegberg-Dalheim (DE)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/250,659

(22) PCT Filed: Jan. 4, 2002
(86) PCT No.: PCT/EP02/00039

(30) Foreign Application Priority Data
Jan. 5, 2001 (DE) 201 00 121.7

(51) Int. Cl. B01F 3/04

(52) U.S. Cl. 261/79.2; 422/4; 422/28

(57) ABSTRACT

A device for enriching air with an air treatment agent, particularly for the sterilization of air, comprises a swirl chamber (10). The swirl chamber (10) has a feed opening (12) through which the air treatment agent is fed to the swirl chamber (10). Further, the swirl chamber (10) has an air entrance opening (18) as well as an air exit opening (46). In a region of the air swirl chamber (10), which is enlarged in a funnel-shaped manner, a swirling means (34) is provided. Advantageously, the latter comprises star-shaped/slots (40) as well as a perforated plate (36). By means of the swirling means, the air in the swirl chamber (10) is swirled such that air enriched with air treatment agent exits the swirl chamber (10). The enrichment with air treatment agent is so minor that no precipitation of air treatment agent can be detected in the room in which the air treated with air treatment agent is directed.

The invention relates to a device for enriching air with an air treatment agent, particularly for the sterilization of air.

During the cooling of bread, cake, and pastries after the baking process, it has to be avoided, for example, that mold germs deposit on the surface before packing. To this end, complicated air filtering facilities with different filtering systems are utilized. Since, in this connection, the mould germs often deposit in the filtering facilities, the filters themselves often act as mold formation focus. Therefore, the filters have to be cleaned often and very thoroughly.

When storing cheese after ripening, an undesired mold formation on the cheese surface also occurs due to mold germs in the air. In order to avoid this, cheese are coated by a covering agent, for example, in which an antibiotic is contained. Because of diffusion, the antibiotic enters into the outer region of the cheese. The use of filtering facilities in the preparation of cheese has the same disadvantage as in the preparation of bread, cake, and pastries.

Another field of application is the air treatment in apartments (e.g., of allergies), office buildings, means and fields of transport, hygienic areas of productions, storage, packing, in health service and the like.

Further, evaporators are known for the treatment of air wherein an air treatment agent is evaporated by the supply of heat. With such an evaporation of the air treatment agent, the air is enriched with the treatment agent to a relatively high degree so that the treatment agent precipitates in the room to be treated. A precipitation of the air treatment agent cannot be avoided either by clocking an evaporator working because of the supply of heat. The precipitation only occurs within certain time limits.

With spray compressed-air systems, the amount of sprayed air treatment agent is also so large that a part of the air treatment agent precipitates.

Such evaporators cannot be used for the treatment of cooling rooms for bread, cake and pastries or cheese storage rooms since the air treatment agent would deposit on the food. With the treatment of room air, the evaporation of an air treatment agent also has the disadvantage that the air treatment agent precipitates on cool windows, for example.

It is the object of the invention to provide a device for enriching air with an air treatment agent, which can also be used in the field of food.

This object is solved, according to the invention, with the features of claim 1.

The device of the invention for enriching air with an air treatment agent, particularly for sterilizing air, comprises a swirl chamber. The swirl chamber has a feed opening to feed liquid air treatment agent to the swirl chamber. The swirl chamber further comprises an air entrance opening through which air is fed to the swirl chamber. Additionally, the swirl chamber comprises an exit opening through which a mixture of air and air treatment agent in the vapor state exits. Further, the device according to the invention comprises a means for generating an airstream, such as a sucking or blowing fan, for example. By the means for generating an airstream, an airstream is generated in the swirl chamber which enters into the swirl chamber at the entrance opening and exits it at the exit opening, together with the air treatment agent in the vapor state.

The airstream effects a swirling of the air treatment agent in the swirl chamber. By swirling the air treatment agent, the air absorbs a small amount of air treatment agent so that a mixture of air and air treatment agent in the vapor state exits the swirl chamber. In this connection, the amount of air treatment agent absorbed by the airstream is so small that no precipitation of the air treatment agent on objects is detectable. In this connection, the mixture of air and air treatment agent exiting the exit opening preferably has an air treatment agent portion of between 0.1 and 0.00001 ml, preferably of between 0.01 and 0.0001 ml, per m; of air per hour.

According to the invention, the swirl chamber is flared in a funnel-shaped manner after the exit opening, i.e., in the direction of the airstream in order to achieve a sufficient swirling of the air treatment agent. Thereby, the air pressure changes corresponding to a Venturi nozzle. This leads to a swirling of the air. Preferably, the swirl chamber is rotationally symmetric, at least in the region of the funnel-shaped widening.

Preferably, the air treatment agent is fed discontinuously via the feed opening. Experiments have shown that in a device according to the invention with an air throughput of about 8 m;/h, a feed of 20 g of air treatment agent per hour at a time should not be exceeded. Preferably, a smaller amount of air treatment agent, particularly less than 15 g, is fed. It is further possible to feed air treatment agent continuously or small amounts of air treatment agent at fixed time intervals to the swirl chamber by providing an appropriate pump.

To achieve an as good swirling of the air treatment agent as possible and to ensure that no or only small amounts of air treatment agent are able to escape from the air entrance opening of the swirl chamber, the cross section of the entrance opening has a ratio of 1:5-1:10, preferably of 1:7-1:8, to the cross section of the swirl chamber.

A further improvement of the swirling of the air treatment agent can be achieved by providing a swirling means in the swirl chamber. Preferably, the swirling means is arranged in the funnel-shaped transition region, i.e., near the air entrance opening of the swirl chamber. Preferably, the swirling means are slots arranged in a star-shaped manner. Such slots the width of which changes over the cross section of the swirling means cause a swirling of the air since, in dependence on the slot width, the airstream is differently braked and accelerated, respectively. In this connection, the arrangement of the slots is not parallel to the direction of the airstream. Preferably, the slots are arranged obliquely with respect to the flow direction of the airstream.

By forming slots arranged in a star-shaped manner, it is possible, depending on the configuration of the slots, to provide triangular elements between the slots, acting as dam sheet metals. These dam sheet metals arranged in the flow direction of the air, preferably obliquely, preferably direct the air in the direction of a central axis of the swirl chamber. Thereby, the swirling of the air treatment agent in the swirl chamber is further improved.

In addition to or instead of the slots arranged in a star-shaped manner, the swirling means may comprise a perforated plate. Preferably, the perforated plate is arranged vertically to the flow direction of the air. By providing a perforated plate with preferably very small holes, a kind of atomization of the air treatment agent is effected so that only a very small portion of air treatment agent is absorbed by the air. Preferably, the cross-sectional area of the openings of the perforated plate has a ratio of 1:100-5:100 to the entire cross-sectional area of the perforated plate. The ratio of 2:100-4:100 is particularly preferred. Preferably, the diameter of the individual holes is smaller than 3 mm, particularly smaller than 2.5 mm, if the holes are round. Per cm5 of perforated plate, preferably at least one hole with such a diameter or a corresponding cross-sectional area is provided.

The airstream entering through the air entrance opening into the swirl chamber amounts to at least 1 m;/h, preferably at least 5 m;/h, particularly preferably at least 10 m;/h. The fed air treatment agent that may be fed continuously or discontinuously preferably has an amount of maximally 30 g/h, particularly preferably of maximally 20 g/h and particularly of maximally 15 g/h.

Particularly, it is also possible, in industrial applications, for example, to use facilities with a throughput of 50,000 m;/h, particularly of 100,000 m;/h and more. With such facilities in particular, the amount of the fed air treatment agent may also amount up to 10,000 g/h. With very small facilities in particular, it is also possible to feed the room with air treatment agents in quantitative ranges of 0.0001 g/h to 0.001 g/h.

According to the configuration of the swirl chamber flared in a funnel-shaped manner from the air entrance opening, wherein effects of the kind of a Venturi tube occur, flow velocities of more than 30 m/s, preferably more than 40 m/s, and particularly preferably more than 50 m/s occur at the air entrance opening.

Further, experiments have shown that it is advantageous when the maximum water content of the air treatment agent amounts to less than 25%, particularly less than 23%, to avoid the formation of condensate in the room to which air treatment agent is fed.

In experiments with an air sterilization agent, a treatment agent portion of 0.01 ml/m; of air has been achieved with an air throughput of about 1,100 m;/h. Thus, with the ratios between air and treatment agent indicated above, only a very small portion of air treatment agent is absorbed in the air. This is a surprising effect since only a very small portion of air treatment agent is absorbed by the air due to the swirling. It is not possible to introduce such small amounts of air treatment agent into the air by spraying techniques or by heat evaporation. This is not possible in particular if known devices are operated without clocking. With the device according to the invention, however, the above result has been achieved without clocking.

In order to ensure that really no precipitating areosol escapes from the device, an intermediate chamber is connected downstream with respect to the swirl chamber. A retaining disc is provided between the intermediate chamber and the swirl chamber. Air treatment agent droplets possibly entrained by the airstream are retained by the retaining disc, on the one hand, and condense out in the intermediate chamber, on the other hand.

Preferably, filters precede the air entrance openings of the swirl chamber to feed an air as free of germs, particles, and bacteria as possible to the device. To this end, a particle filter and/or a bacteria filter and/or a humidity filter are provided.

Advantageously, the device is coupled with an air conditioning plant so that the distribution of the air treatment agent in the entire room is guaranteed by the air conditioning plant.

In another embodiment, a pressure generation means is connected downstream with respect to the device, which increases the pressure of the exiting mixture of air and air treatment agent in the vapor state. Such a device can be used, for example, to ensure that the mixture is also blown into the corners of a room.

With the device according to the invention, particularly the air treatment agents mentioned in the International Patent Application PCT/EP 0 002 992, particularly the air sterilization agents, can be put out into the air of a room to be treated.

Hereinafter, the invention will be explained in detail with respect to preferred embodiments with reference to the accompanying drawings.

In the Figures:

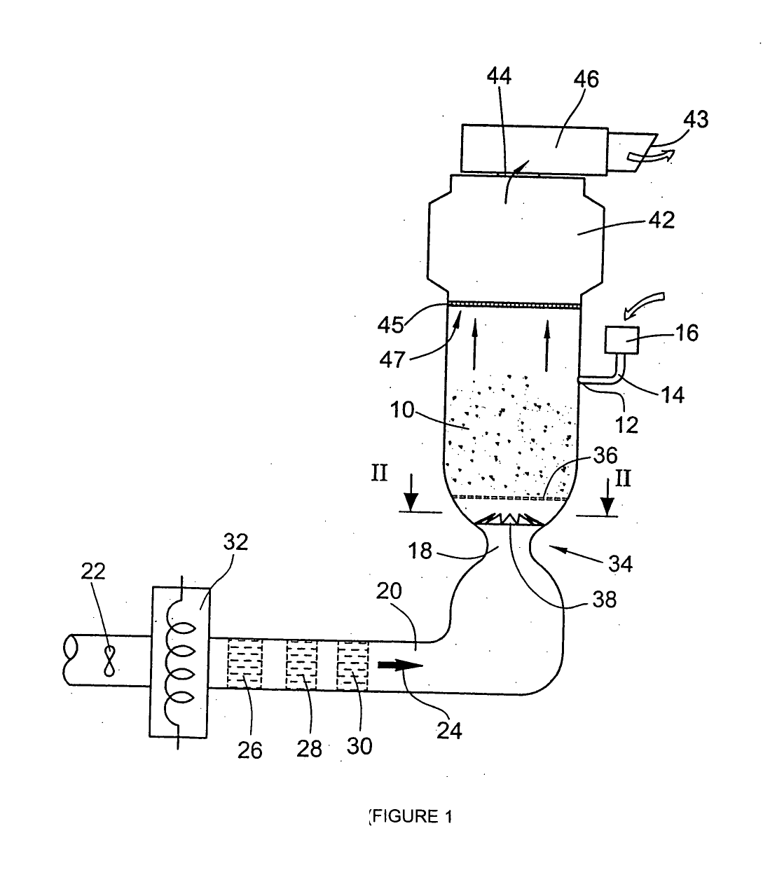

FIG. 1 shows a schematic side view of the device according to the invention, and

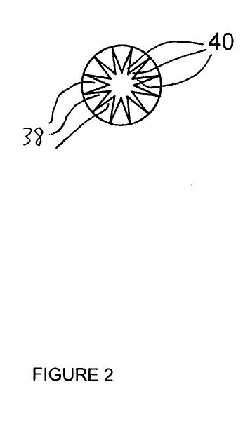

FIG. 2 is a sectional view along the line II-II in FIG. 1.

The device for enriching air with an air treatment agent according to the invention comprises a swirl chamber 10. The swirl chamber 10 has an entrance opening 12 connected with a filling container 16 via a tube 14. The air treatment agent is fed to the swirl chamber 10 via the filling container 16. A specific predetermined amount of air treatment agent can be easily fed to the swirl chamber via the filling container. Instead of a filling container 16, it is also possible to provide a pump connected with a reservoir, continuously delivering air treatment agent into the swirl chamber 10. Likewise, predetermined amounts of air treatment agent can be fed to the swirl chamber by means of a pump and a corresponding circuit at predetermined time intervals.

The swirl chamber 10 has an air entrance opening 18 through which air is fed to the swirl chamber 10. To this end, a fan 22 generating an airstream in the direction of the arrow 24 is provided in a feed line 20. Further, filters 26,28,30 are arranged in the feed line. The filters 26,28,30 are a particle filter, particularly a pollen filter 26, a bacteria filter 28 as well as a humidity filter 30. Further, a heating installation 32 for preheating the air fed in the swirl chamber 10 is provided in the feed line 20.

To improve the swirling in the swirl chamber, a swirling means 34 is provided in the funnel-shaped regions of the swirl chamber 10 which are arranged behind the air entrance opening 18. In the illustrated embodiment, the swirling means 34 comprises a perforated plate 36 as well as triangular segments 38. The perforated plate 36 extends over the entire width of the swirl chamber 10. Preferably, the perforated plate 36 is arranged horizontally or vertically to the flow direction of the air. Thus, the air has to flow compulsorily through the openings of the perforated plate 36.

The triangular elements 38 are arranged along a circle, the tips of the triangular elements 38 pointing inwards. The triangular elements 38 are arranged such that slots 40 arranged in a star-shaped manner (FIG. 2) are formed. The width of the slots 40 inwardly increases from outside.

Further, the triangular elements 38 may be configured such that they are configured to be pivoted upwards and downwards in FIG. 1. Thereby, it is possible to vary the width of the slots 40. Since, with respect to the flow direction of the air, the triangular elements 38 are arranged obliquely, the width of the slots 40 increases in flow direction. Further, the elements 38 serve to direct the air inwards. This results in an increased swirling of the air.

The swirl chamber 10 is followed by an intermediate chamber 42 to ensure that no liquid air treatment agent from the swirl chamber 10 can come toward an outlet 43 through which the air enriched with air treatment agent flows into a room. From the swirl chamber 10, the intermediate chamber 42 is separated by a retaining disc 45 which is, for example, an appropriate perforated plate or a suitable diaphragm. The retaining disc 45 is arranged in the outlet opening 47 of the swirl chamber 10.

The intermediate chamber 42 is followed by a fitting 44 through which the air enriched with air treatment agent flows into an outlet channel 46.

1. A device for enriching air with an air treatment agent, particularly for the sterilization of air, comprising
a) a swirl chamber (10) with
b) a feed opening (12) for feeding liquid air treatment agent,
c) an air entrance opening (18) through which air is fed to the swirl chamber (10), and
d) an exit opening (47) through which a mixture of air and air treatment agent in the vapor state exits,
e) a means (22) for generating an airstream in the swirl chamber (10) so that the liquid air treatment agent is swirled by the airstream,
f) the swirl chamber (10) being flared in a funnel-shaped manner after the entrance opening (18).

2. The device according to claim 1, characterized in that the cross-sectional area of the entrance opening (18) has a ratio of 1:5-1:10, preferably of 1:7-1:8, to the cross-sectional area of the swirl chamber (10).

3. The device according to claim 1 or 2, characterized in that a swirling means (34) is provided in the swirl chamber (10).

4. The device according to claim 3, characterized in that the swirling means (34) is provided in the funnel-shaped transition region.

5. The device according to claim 3 or 4, characterized in that the swirling means (34) preferably comprises slots (38) arranged in a star-shaped manner.

6. The device according to claim 5, characterized in that the slots (38) are arranged obliquely to the flow direction.

7. The device according to claim 5 or 6, characterized in that the width of the slots (38) increases in flow direction.

8. The device according to one of claims 3-7, characterized in that the swirling means (34) comprises a perforated plate (36).

9. The device according to claim 8, characterized in that the cross-sectional area of the openings of the perforated hole (36) amounts to 1:100-5:100, preferably 2:100-4:100, to the entire cross-sectional area of the perforated hole (36).

10. The device according to claim 8 or 9, characterized in that at least one preferably round hole with a diameter of less than 3 mm, preferably of less than 2.5 mm, is provided per cm5.

11. The device according to one of claims 8-10, characterized in that the perforated hole (36) extends over the entire cross section of the swirl chamber (10).

12. The device according to one of claims 8-11, characterized in that the perforated hole (36) is arranged in addition to the star-shaped slots (40), preferably in the flow direction of the air downstream of the slots (40).

13. The device according to one of claims 1-12, characterized in that the airstream amounts to at least 1 m;/h, preferably at least 5 m;/h, particularly preferably at least 10 m;/h.

14. The device according to one of claims 1-13, characterized in that the fed air treatment agent amounts to maximally 30 g/h, preferably maximally 20 g/h, particularly preferably maximally 15 g/h.

15. The device according to one of claims 1-14, characterized in that the feed of the air treatment agent is discontinuous.

16. The device according to one of claims 1-15, characterized in that the flow velocity at the entrance opening (18) is greater than 30 m/s, preferably greater than 40 m/s and particularly preferably greater than 50 m/s.

17. The device according to one of claims 1-16, characterized in that the air treatment agent has a maximum water content of less than 25%, particularly of less than 23%.

18. The device according to one of claims 1-17, characterized in that the air entrance opening (18) is preceded by a heating installation (32) for heating the entering air.

19. The device according to one of claims 1-18, characterized in that subsequent to the swirl chamber (10), an intermediate chamber (42) separated from the swirl chamber (10) by a retaining disc (45) with passage openings is provided.

20. The device according to one of claims 1-19, characterized in that the air entrance opening (18) is preceded by a particle filter (26) and/or a bacteria filter (28) and/or a humidity filter (30).

21. The device according to one of claims 1-20, characterized in that in the mixture of air and air treatment agent fed in the room to be treated, between 0.1 and 0.00001 ml, preferably between 0.01 and 0.0001 ml of air treatment agent are contained per m; of air per hour.

22. The device according to one of claims 1-21, characterized in that in the mixture of air and air treatment agent fed in the room to be treated, the air treatment agent portion is # 100 ppt, preferably # 10 ppt.

23. The device according to one of claims 1-22, characterized in that an antimicrobial composition is used as air treatment agent.

24. The device according to claim 23, characterized in that the antimicrobial composition contains one or more GRAS flavors or derivatives thereof.
